(19) United States
(12) Patent Application Publication
(10) Pub. No.: US 2018/0182215 A1
(43) Pub. Date: Jun. 28, 2018

(54) Method for Auto-enabling an Information-Capturing Device and Intelligent Mobile Surveillance System

(71) Applicant: GETAC TECHNOLOGY CORPORATION, HSINCHU COUNTY (TW)

(72) Inventor: Chao-Long Jen, Taipei City (TW)

(21) Appl. No.: 15/730,693

(22) Filed: Oct. 11, 2017

Related U.S. Application Data
(60) Provisional application No. 62/438,962, filed on Dec. 23, 2016.

(51) Int. Cl. G08B 13/196; G08B 25/10; G08B 25/00; G08B 25/01

(52) U.S. Cl. CPC G08B 13/19669; G08B 13/19671; H04N 7/181; G08B 25/002; G08B 25/016; G08B 25/10

(57) ABSTRACT

A method for auto-enabling an information-capturing device includes sensing a motion of a wearer to generate a motion signal by a motion sensing unit of a wearable device, determining whether the motion signal matches a motion template by a processing unit of the wearable device, and sending an enabling signal when determining that the motion signal matches the motion template by a wireless transmitting unit of the wearable device, such that an information-capturing device starts to capture an environmental data upon receiving the enabling signal.

### BACKGROUND OF THE INVENTION

### Field of the Invention

The present invention relates to a mobile surveillance technology, and more particularly, to a method for auto-enabling an information capturing device and an intelligent mobile surveillance system.

### Description of the Prior Art

In general, a portable information capturing device captures multimedia data including images and sounds. With the rising of security awareness of the public, portable information capturing devices, featuring ready portability and real-time information capturing capability, can serve as security auxiliary devices and are thus extensively applied in all fields.

For example, a law reinforcement officer on duty may wear a portable information capturing device to assist in executing law reinforcement tasks. Further, multimedia data captured by the portable information capturing device can later serve as evidence and responsibility clarification purposes. Because the process and rightness of law reinforcement officers in using firearms can evoke controversies in social, legal and political aspects, objective evidences are much needed as basis for clarifying doubts and resolving disputes.

In view of the above, the application of synchronous forensics during law reinforcement of law reinforcement officers is currently becoming popular. In-car video surveillance systems and body-worn cameras are some common forensic devices. These above products all need to be manually activated by law reinforcement officers in order to conduct related forensic work. However, usually law reinforcement officers need to use firearms only when encountering emergencies happening in an extremely short period. In a highly tense and complex situation, law reinforcement officers may easily overlook in activating or have no time to activate a device, such that law reinforcement officers may be incapable of providing objective evidences for clarifying legal responsibilities after such event.

To enable a forensic device to more effectively exercise its functions in events of emergencies and to prevent law reinforcement officers from being distracted from duty, some manufacturers provide products or solutions that automatically activate the forensic function. Currently, there are commercially available intelligent holsters that automatically activate the forensic function when a firearm disengages from the holster, or in-car sensors that detect the activation of police sirens and trigger the forensic function.

However, various limitations lie in the actual operations of the above products. For example, a product can support only specific holster or firearms instead of being universally suitable for most police equipment. Further, although an intelligent holster is capable of sensing that a firearm is disengaged from a holster, it does not necessarily mean that a law reinforcement officer is for sure using or preparing to use the firearm. Further, an in-car sensor needs to be allocated in a vehicle and applied in conjunction with other associated sensors, thus restricting the applicable law reinforcement units and application scenarios.

### SUMMARY OF THE INVENTION

According to an embodiment, a method for auto-enabling an information capturing device includes sensing a motion of a wearer to generate a motion signal by a motion sensing unit of a wearable device, determining whether the motion signal matches a motion template by a processing unit of the wearable device, and transmitting an enabling signal by a wireless transmission unit of the wearable device when it is determined that the motion signal matches the motion template, so as to cause the information capturing device to start capturing environmental data upon receiving the enabling signal.

In one embodiment, an intelligent mobile surveillance system includes a wearable device. The wearable includes a motion sensing unit, a processing unit, a wireless transmission unit, a storage unit and an information capturing unit. The motion sensing unit senses a motion of a wearer to generate a motion signal. The processing unit is connected to the motion sensing unit, and determines whether the motion signal matches a motion template. The wireless transmission unit is connected to the processing unit, and transmits an enabling signal when the processing unit determines that the motion signal matches the motion template. The storage unit is connected to the processing unit, and stores the motion template. The information capturing unit captures environmental data upon wirelessly receiving the enabling signal.

In conclusion, the method for auto-enabling an information capturing device and the intelligent mobile surveillance system are suitable for sensing a motion of a wearer to immediately and automatically capture various types of data, record events and take subsequent corresponding measures. The method and system according to the embodiments of the present invention are capable of accurately determining the event of an emergency and appropriately taking evidence, and can thus be extensively applied in apparatuses associated with duties of police offers and security staff.

Detailed characteristics and advantages of the present invention are given in the embodiments below. The disclosure is sufficient for one person skilled in the art to understand and accordingly implement the technical contents of the present invention. Based on the description, claims and drawings of the disclosure, one person skilled in the art can easily appreciate the objects and advantages of the present invention.

### BRIEF DESCRIPTION OF THE DRAWINGS

FIG. 1 is a system architecture diagram of an intelligent mobile surveillance system according to an embodiment;

FIG. 2 is a block diagram of an intelligent mobile surveillance system according to an embodiment;

FIG. 3 is a flowchart associated with a wearable device when a method for auto-enabling an information capturing device is performed according to an embodiment;

FIG. 4 is a flowchart associated with an information capturing device and a cloud server or a workstation when a method for auto-enabling an information capturing device is performed according to an embodiment;

FIG. 5 is a flowchart associated with a relay station and a cloud server or a workstation when a method for auto-enabling an information capturing device is performed according to an embodiment; and

FIG. 6 is another flowchart associated with a relay station and a cloud server or a workstation when a method for auto-enabling an information capturing device is performed according to an embodiment.

### DETAILED DESCRIPTION OF THE EMBODIMENTS

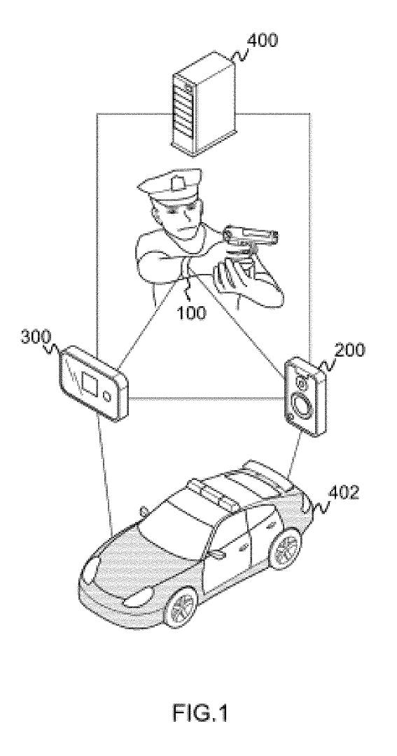

Referring to FIG. 1, in some embodiments, an intelligent mobile surveillance system may include a wearable device 100 and an information capturing device 200. The information capturing device 200 may be signally connected to the wearable device 100.

In some embodiments, the wearable device 100 may be a device (e.g., a headband, hat, hairclip, badge, necklace, wristband or ring) worn at any part of a wearer (e.g., at a head, chest or arm) to sense and analyze a motion of the wearer. In some embodiments, the wearable device 100 is preferably a device (e.g., a wristband or ring) worn at a hand of a wearer to sense an analyze a motion of the hand of the wearer. The information capturing device 200 may record and capturing corresponding environmental data with respect to the surroundings of the wearable device 100.

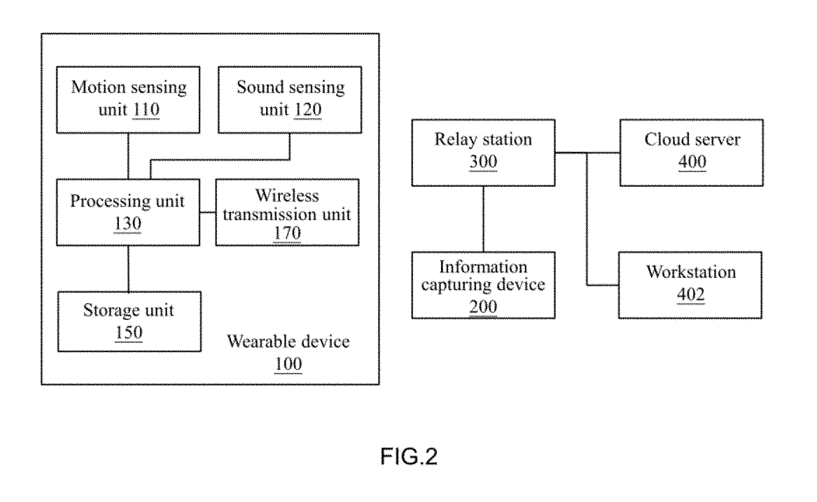

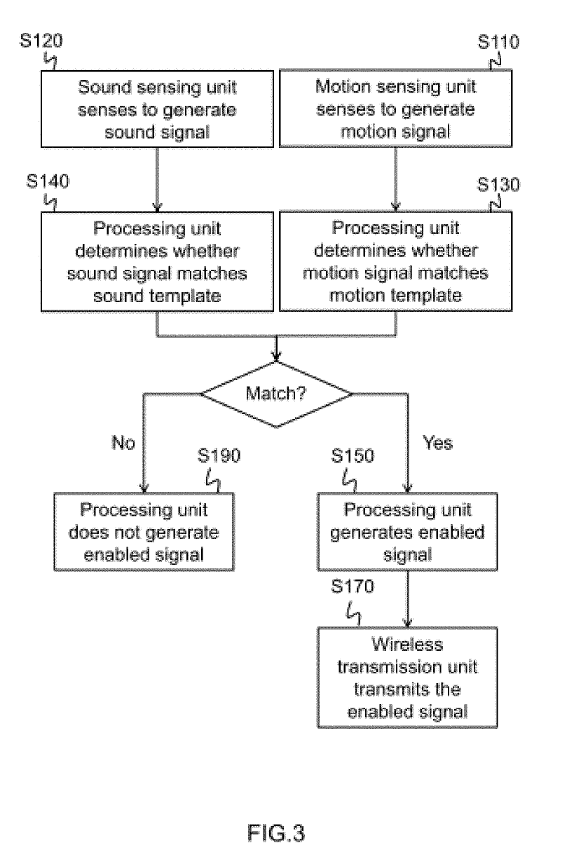

Referring to FIG. 2 and FIG. 3, in some embodiments, the wearable device 100 may include a motion sensing unit 110, a processing unit 130, a storage unit 150 and a transmission unit 170. The processing unit 130 is connected to the motion sensing unit 110, the storage unit 150 and the wireless transmission unit 170. The storage unit 150 stores one or multiple motion templates.

In some embodiments, when a wearer wears and activates the wearable device 100, the motion sensing unit 110 senses a motion of the wearer to generate a motion signal corresponding to the motion of the wearer (step S110). For example, taking an example where the wearable device 100 is worn at a hand of a wearer and the wearer is a law reinforcement officer, when the wearer performs a firearm holding motion and drives the wearable device 100 to move, the motion sensing unit 110 senses the firearm holding motion and generates a motion signal.

At this point, the processing unit 130 of the wearable device 100 determines whether the motion signal matches the motion template (step S130). If the processing unit 130 determines that the motion signal matches the motion template, the processing unit 130 generates an enabling signal (step S150). Further, the wireless transmission unit 170 of the wearable device 100 transmits the enabling signal (step S170). If the motion signal does not match the motion template, the processing unit 130 does not generate the motion signal (step S190). Further, in some embodiments, the processing unit 130 may omit the motion signal or directly record the motion signal in the storage unit 150 in step S190.

In some embodiments, the processing unit 130 may directly compare the motion signal with the motion template to verify whether the motion signal matches the motion template, to accordingly determine whether the motion signal matches the motion template. In some embodiments, the processing unit 130 may first analyze the motion signal to generate a characteristic value in the motion signal, and compare the generated characteristic value with a characteristic value of the motion template to verify whether the generated characteristic value matches the characteristic value of the motion template, to accordingly determine whether the motion signal matches the motion template.

In other words, when the motion signal matches the motion template, it may be that the motion signal is identical or similar to the motion template, the characteristic value of the motion signal is identical or similar to the characteristic value (known characteristic value data) of the motion template, the characteristic value of the motion signal does not exceed a threshold representing the motion template, or a model function representing the motion signal is identical or substantially identical to a model function (a known model function) representing the motion template.

In some embodiments, the motion template may use the motion sensing unit 110 to sense a known standard motion to generate a corresponding motion signal, which is obtained through analyzing the motion signal of the standard motion by the processing unit 130 (e.g., identifying and/or determining a corresponding class of the standard motion through a feature classifier). In other embodiments, the motion template may use the motion sensing unit 110 to sense a motion signal generated from a known standard motion.

In some embodiments, the wearable device 100 further includes a sound sensing unit 120, and the processing unit 130 is connected to the sound sensing unit 120. The storage unit 150 may further store one or multiple sound templates.

In some embodiments, when the wearer wears and activates the wearable device 100, the sound sensing unit 120 senses specific sounds from the wearer or from the ambient environment to generate a sound signal corresponding to the specific sound (step S120). For example, assuming that the wearable device 100 is worn at a hand of the wearer and the wearer is a law reinforcement officer, when the wearer engages a firearm and causes the firearm to make a sound, the sound sensing unit 100 senses a gunshot and generates a sound signal.

At this point, the processing unit 130 of the wearable device 100 determines whether the sound signal matches the sound template (step S140). If the processing unit 130 determines that the sound signal matches the sound template, the processing unit 130 generates the enabling signal (step S150). Further, the wireless transmission unit 170 of the wearable device 100 transmits the enabling signal (step S170). If the sound signal does not match the sound template, the processing unit 130 does not generate the enabling signal (step S190). Further, in some embodiments, the processing unit 130 may omit the sound signal or directly record the sound signal in the storage unit 150 in step S190.

In some embodiment, the processing unit 130 may directly compare the sound signal with the sound template to verify whether the sound signal matches the sound template, to accordingly determine whether the sound signal matches the sound template. In some embodiments, the processing unit 130 may first analyze the sound signal to generate a characteristic value in the sound signal, and compare the generated characteristic value with a characteristic value of the sound template to verify whether the generated characteristic value matches the characteristic value of the sound template, to accordingly determine whether the sound signal matches the sound template.

In other words, when the sound signal matches the sound template, it may be that the sound signal is identical or similar to the sound template, the characteristic value of the sound signal is identical or similar to the characteristic value (known characteristic value data) of the sound template, the characteristic value of the sound signal does not exceed a threshold representing the sound template, or a model function representing the sound signal is identical or substantially identical to a model function (a known model function) representing the sound template.

In some embodiments, the sound template may use the sound sensing unit 120 to sense a known standard sound to generate a corresponding sound signal, which is obtained through analyzing the sound signal of the standard sound by the processing unit 130 (e.g., identifying and/or determining a corresponding class of the standard sound through a feature classifier). In other embodiments, the sound template may use the sound sensing unit 110 to sense a sound signal generated from a known standard sound.

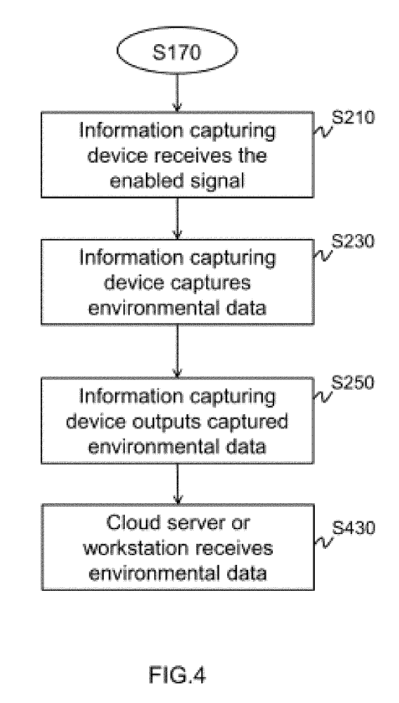

Referring to FIG. 4, in some embodiments, when the information capturing device 200 receives the enabling signal transmitted from the wireless transmission unit 170 of the wearable device 100 (step S210), the information capturing device 200 captures environmental data (step S230) and outputs the captured environmental data (step S250).

In some embodiments, the information capturing device 200 may include at least one of a body-worn camera, a sound recording device, a driving recorder, a monitor, a mobile surveillance device, a smart phone, and an equivalent multimedia capturing device or the combinations thereof. In some embodiments, the environmental data captured by the information capturing device 200 may be at least one of temperature, humidity, luminosity, acceleration, pressure, sound, image, or other data or information for identifying environmental changes, or the combinations thereof.

For example, when an on-duty law reinforcement officer wearing a wristband (i.e., the wearable device 100) encounters an emergency, particularly in a situation where a firearm is needed for law reinforcement, the wristband senses a hand motion of using the firearm, e.g., drawing the firearm, gripping a firearm handle, lifting the firearm, holding the firearm, releasing a firearm safety, aiming the firearm and shooting the firearm, and generates a motion signal. The processing unit 130 determines whether the motion signal matches the motion template. When the processing unit 130 determines that the motion signal matches the motion template, the wireless transmission unit 170 transmits the enabling signal. Further, the processing unit 130 determines whether the sound signal matches the sound template. When the processing unit 130 determines that the sound signal matches the sound template, the wireless transmission unit 170 also transmits the enabling signal. A body-worn camera or monitor (i.e., the information capturing device 200) located near the law reinforcement officer may receive the enabling signal and start capturing environmental data, and output the environmental data to an appropriate device or apparatus (e.g., a cloud server or workstation). The environmental data may serve as evidence and a history record obtained during the event for the law reinforcement officer.

Again referring to FIG. 1 and FIG. 2, in some embodiments, the intelligent mobile surveillance system may include a relay station 300, a cloud server 400 and a workstation 402. The relay station 300 may be signally connected to the wearable device 100 and/or the information capturing device 200. The cloud server 400 or the workstation 402 may be signally connected to the information capturing device 200 and/or the relay station 300.

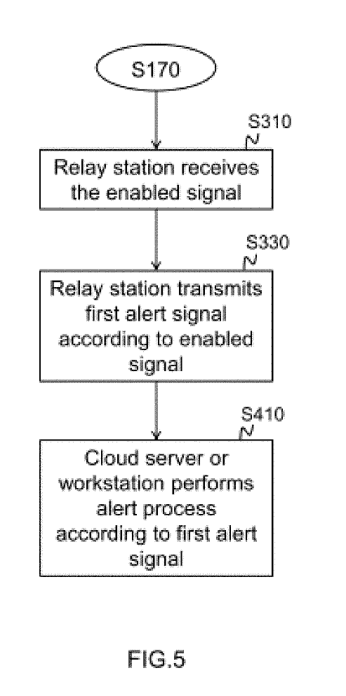

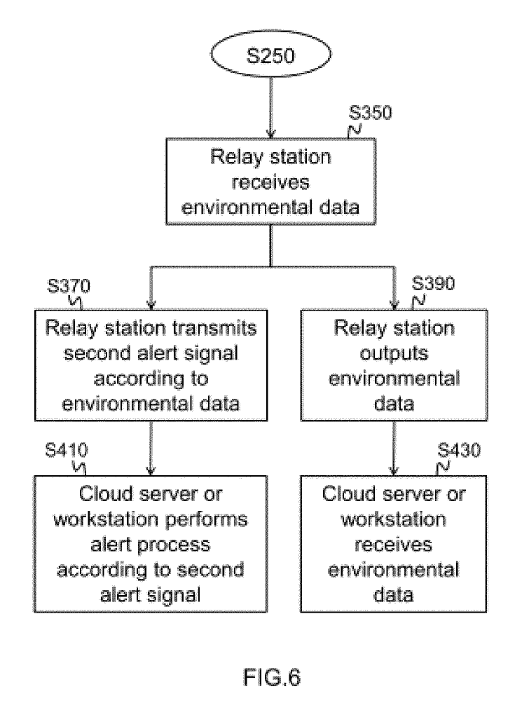

Referring to FIG. 5 and FIG. 6, in some embodiments, the relay station 300 may receive the enabling signal transmitted from the wireless transmission unit 170 of the wearable device 100 (step S310), and transmit a first alert signal according to the enabling signal (step S330). In other embodiments, the relay station 300 may receive the environmental data outputted from the information capturing device 200 (step S350), and transmit a second alert signal according to the environmental data. After the first alert signal or the second alert signal from the relay station 300 is received by the cloud server 400 or the workstation 402, the cloud server 400 or the workstation 402 may perform an alert process according to the first alert signal or the second alert signal (step S410).

Again referring to FIG. 6, in some embodiments, the relay station 300, after receiving the environmental data (step S350), outputs the environmental data (step S390). At this point, the cloud server 400 or the workstation 402 receives the environmental data outputted from the information capturing device 200 and/or the relay station 300 (step S430), so as to perform the subsequent recording and identification of the event near the wearable device 100 and the corresponding alert process. In some embodiments, the cloud server 400 or the workstation 402 may simultaneously or non-simultaneously receive the environmental data from the information capturing device 200 and the relay station 300.

In some embodiments, the relay station 300 may include a portable electronic device such as a cell phone, a tablet computer or a gateway having a wireless connection function, and more particularly, a wearable smart gateway.

In some embodiments, the cloud server 300 may include one or more hosts, and more particularly for a cloud server deployed at a police station, a security unit or any unit associated with law reinforcement.

In some embodiments, the workstation 402 may include a vehicle provided with a video camera and/or a computer, for example, a police vehicle.

For example, after the wristband of the law reinforcement officer sends the enabling signal, the relay station 300 receives the enabling signal or the environmental data, or simultaneously or non-simultaneously receive the enabling signal and the environmental data, and sends the first alert signal and/or the second alert signal to the cloud server 400 or the workstation 402. After receiving the first alert signal or the second alert signal, the cloud server 400 or the workstation 402 may perform processes including identification, monitoring and recording of the event, sending messages to related personnel or equipment, work dispatch, tracking and support. Further, in some embodiments, the information capturing device 200 and the relay station 300 may also directly transmit the environmental data to the cloud server 400 or the workstation 402 for recording and information backup of the event.

In some embodiments, the motion sensing unit 110 may include at least one of an accelerometer, a gyroscope, a G-sensor, a strain gauge, a magnetometer, other apparatuses with a motion sensing capability, or the combinations thereof.

In some embodiments, the sound sensing unit 110 may include a microphone, an amplifier and an analog-to-digital converter (ADC). The microphone sends an analog signal of a sound after receiving the sound, and the amplifier amplifies the analog signal from the microphone and outputs the amplified analog signal to the ADC to generate a digital signal (i.e., the sound signal). Further, in some embodiments, the microphone may be at least one of a dynamic microphone, a condenser microphone, an electric condenser microphone, an MEMS microphone, a ribbon microphone, a carbon microphone, other equivalent devices, or the combinations thereof.

In some embodiments, the processing unit 130 may be a system-on-chip (SoC), a central processing unit (CPU) or a microcontroller unit (MCU).

In some embodiments, the processing unit 130 may train and update the motion template through machine learning. For example, analysis, statistics and classification may be performed according to a predetermined motion that one or multiple wearers repeatedly perform, e.g., drawing a firearm or holding a firearm, to obtain a predetermined motion signal, or a threshold or tolerance of a characteristic value of the predetermined motion signal, and the predetermined motion signal is stored as the motion template. Further, in some embodiments, the predetermined motion signal or its characteristic value may be compared with an existing motion template or a characteristic value of the existing motion template for a similarity between the two. If the predetermined motion signal or its characteristic value is identical or very similar to (e.g., exceeding a similarity threshold) the existing motion template or the characteristic value of the existing motion template, the predetermined motion signal can be discarded.

For example, when a law reinforcement officer wearing the wristband performs a predetermined hand motion, e.g., drawing a firearm or holding a firearm, a motion signal or its characteristic value obtained according to the predetermined hand motion is stored as the motion template or the characteristic value of the motion template. Further, if multiple wearable devices are wirelessly connected to one another, multiple hand motions may be recorded, and the motion signal and its characteristic value may be established and stored through statistics and classification.

In some embodiments, the processing unit 130 may also train and update the sound template through machine learning. For example, analysis, statistics and classification may be performed according to a predetermined sound (e.g., a gunshot, a firebomb exploding, or a police siren) that one or multiple wearer repeatedly generate to obtain a predetermined sound signal or a threshold or tolerance of the predetermined sound signal. Further, the predetermined sound signal is stored as the sound template. For example, the standard sound may have characteristic values, e.g., amplitude, frequency, tone, sound speed, sound source, transmission distance and arrival time of a sound, for distinguishing or identification purposes. Further, in some embodiments, the predetermined sound signal or its characteristic value may be compared with an existing sound template or a characteristic value of the sound motion template for a similarity between the two. If the predetermined sound signal or its characteristic value is identical or very similar to (e.g., exceeding a similarity threshold) the existing sound template or the characteristic value of the existing sound template, the predetermined sound signal can be discarded.

For example, when a law reinforcement officer wearing the wristband generates a predetermined sound according to different scenarios or different types of weapons held, e.g., a gunshot from shooting a handgun, a sound signal or its characteristic value obtained according to the gunshot is stored as the sound template or the characteristic value of the sound template. Further, if multiple wearable devices are wirelessly connected to one another, multiple gunshots may be recorded, and the sound signal and its characteristic value may be established and stored through statistics and classification.

In some embodiments, the storage unit 150 may be implemented by one or multiple storage elements. Each storage element may be a non-volatile memory, e.g., a ROM or a flash memory, or a volatile memory, e.g., a RAM.

In some embodiments, the wireless transmission unit 170 may be a Bluetooth transmission unit, e.g., a transmission unit based on the Classic Bluetooth, Bluetooth high speed, or Bluetooth low energy protocol. At this point, the wearable device 10 may broadcast the enabling signal through the Bluetooth transmission unit.

In conclusion, the method for auto-enabling an information capturing device and the intelligent mobile surveillance system are suitable for sensing a motion of a wearer to immediately and automatically capture various types of data, record events and take subsequent corresponding measures. The method and system according to the embodiments of the present invention are capable of accurately determining the event of an emergency and appropriately taking evidence, and can thus be extensively applied in apparatuses associated with duties of police offers and security staff.

While the invention has been described in terms of what is presently considered to be the most practical and preferred embodiments, it is to be understood that the invention is only illustrative and needs not to be limited to the above embodiments. It should be noted that, equivalent variations and replacements made to the embodiments are to be encompassed within the scope of the present invention. Therefore, the scope of the present invention is to be accorded with the appended claims.

What is claimed is:

1. A method for auto-enabling an information capturing device, comprising:
sensing a motion of a wearer by a motion sensing unit of a wearable device to generate a motion signal;
determining whether the motion signal matches a motion template by a processing unit of the wearable device;
transmitting an enabling signal by a wireless transmission unit of the wearable device when it is determined that the motion signal matches the motion template, to cause the information capturing device to start capturing environmental data upon receiving the enabling signal.

2. The method for auto-enabling an information capturing device according to claim 1, further comprising:
sensing a sound from the wearer by a sound sensing unit of the wearable device to generate a sound signal;
determining whether the sound signal matches a sound template by the processing unit of the wearable device;
transmitting the enabling signal by the wireless transmission unit of the wearable device when it is determined that the sound signal matches the sound template, to cause the information capturing device to start capturing the environmental data upon receiving the enabling signal.

3. The method for auto-enabling an information capturing device according to claim 1, wherein the step of transmitting the enabling signal by the wireless transmission unit of the wearable device comprises:
broadcasting the enabling signal by the wireless transmission unit.

4. The method for auto-enabling an information capturing device according to claim 3, further comprising:
receiving the enabling signal by a relay station; and
transmitting a first alert signal to a cloud server or a workstation according to the received enabling signal by the relay station.

5. The method for auto-enabling an information capturing device according to claim 4, further comprising:
after the information capturing device starts capturing the environmental data, transmitting the captured environmental data to the relay station, the cloud server or the workstation by the information capturing device.

6. The method for auto-enabling an information capturing device according to claim 5, further comprising:
transmitting a second alert signal to the cloud server or the workstation according to the received environmental data by the relay station.

7. The method for auto-enabling an information capturing device according to claim 1, wherein the environmental data is temperature, humidity, luminosity, acceleration, pressure, sound or image.

8. The method for auto-enabling an information capturing device according to claim 1, wherein the information capturing device is a body-worn camera, a sound recording device, a driving recorder, a monitor, a mobile surveillance device or a smart phone.

9. An intelligent mobile surveillance system, comprising:
a wearable device, comprising:
a motion sensing unit, for sensing a motion of a wearer to generate a motion signal;
a processing unit, connected to the motion sensing unit, for determining whether the motion signal matches a motion template;
a wireless transmission unit, connected to the processing unit, for transmitting an enabling signal when the processing unit determines that the motion signal matches the motion template; and
a storage unit, connected to the processing unit, for storing the motion template; and
an information capturing device, for starting capturing environmental data upon wirelessly receiving the enabling signal.

10. The intelligent mobile surveillance system according to claim 9, further comprising:
a sound detecting unit, for sensing a sound from the wearer to generate a sound signal;
wherein, the processing unit is connected to the sound sensing unit and determines whether the sound signal matches a sound template, and
the wireless transmission unit transmits the enabling signal when the processing unit determines that the sound signal matches the sound template.

11. The intelligent mobile surveillance system according to claim 9, further comprising:
a relay station, for receiving the enabling signal from the wearable device, and transmitting a first alert signal according to the enabling signal.

12. The intelligent mobile surveillance system according to claim 11, further comprising:
a cloud server or a workstation, communicating with the relay station, for receiving the first alert signal and performing an alert process according to the first alert signal.

13. The intelligent mobile surveillance system according to claim 12, wherein the relay station communicates with the information capturing device, receives the environmental data from the information capturing device, and transmits a second alert signal according to the environmental data.

14. The intelligent mobile surveillance system according to claim 13, wherein the cloud server or the workstation receives the second alert signal and performs the alert process according to the second alert signal.

15. The intelligent mobile surveillance system according to claim 9, wherein the relay station is portable.

16. The intelligent mobile surveillance system according to claim 9, wherein the wireless transmission unit is a Bluetooth transmission unit, and the wearable device is a wristband.

17. The intelligent mobile surveillance system according to claim 9, wherein the environmental data is temperature, humidity, luminosity, acceleration, pressure, sound or image.

18. The intelligent mobile surveillance system according to claim 9, wherein the information capturing device is a body-worn camera, a sound recording device, a driving recorder, a monitor, a mobile surveillance device or a smart phone.
